(19) United States
(12) Patent Application Publication
(10) Pub. No.: US 2023/0170723 A1
(43) Pub. Date: Jun. 1, 2023

(54) Method for Low-Noise Charging of Motor Vehicles, and Motor Vehicle

(71) Applicant: Bayerische Motoren Werke Aktiengesellschaft, Muenchen (DE)

(72) Inventor: Richard WISBRUN, Ottobrunn (DE)

(21) Appl. No.: 17/919,165

(22) PCT Filed: Apr. 15, 2021
(86) PCT No.: PCT/EP2021/059782

§ 371 Date: Oct. 14, 2022

(30) Foreign Application Priority Data
Apr. 22, 2020 (DE) 10 2020 110 949.0

(51) Int. Cl. H02J 7/00; B60L 53/66

(52) U.S. Cl. CPC H02J 7/007188; B60L 53/66; B60L 53/302

(57) ABSTRACT

A method for charging at least one electrical energy storage device of a motor vehicle includes (i) acquiring at least one piece of information regarding a charging point selected for the charging process; and (ii) limiting the maximum noise which the motor vehicle or the at least one electrical energy storage device may emit during the charging process, using the at least one piece of information.

### BACKGROUND AND SUMMARY OF THE INVENTION

Battery-operated motor vehicles are known from the prior art. They are charged at charging stations. In particular in the case of fast charging, it may be the case that undesirable noise emissions arise during charging of the motor vehicle. Noise emissions generally increase with charging power. Although a high charging power is generally desirable, the accompanying noise emissions may be unacceptable in some regions (residential areas, pedestrian zones, etc.) but acceptable in other regions (for example in industrial regions, etc.).

One preferred object of the technology disclosed here is to reduce or to alleviate at least one disadvantage of a previously known solution or to propose an alternative solution. One preferred object of the technology disclosed here is in particular to allow fast charging of motor vehicles with preferably simple, inexpensive and easy-to-establish methods, without the noise emissions thereby increasing excessively greatly in regions that are sensitive in relation to noise emissions. Further preferred objects may become apparent from the advantageous effects of the technology disclosed here. The one or more objects is or are achieved by the claimed invention.

The technology disclosed here comprises in particular a method for charging at least one electrical energy storage device of a motor vehicle. The method comprises the following steps:

acquiring at least one item of information from a charging point selected for the charging process; and

limiting the maximum noise emissions that the motor vehicle or the energy storage device are allowed to emit during the charging process using the information.

According to this preferred embodiment, provision may be made for the motor vehicle to use the maximum noise limit value disclosed here to regulate or control the charging process, in particular to regulate or control the cooling device of the electrical energy storage device. For this purpose, for example, signals indicative of a maximum acoustic pressure limit level may be transmitted to a controller responsible for the cooling device of the energy storage device, wherein the signals then lead for example to the cooling fan or the coolant compressor being operated so quietly that the overall noise emissions of the motor vehicle or of the energy storage device comply with a limit value that is specified (for example by legal requirements). The cooling power may thereby be reduced. If, as a result, the cooling device is then not able to provide enough cooling power to cool the electrical energy storage device, provision may be made for the motor vehicle to initiate or specify a reduction in the charging power or the charging current.

The technology disclosed here comprises a further method for charging the at least one electrical energy storage device of the motor vehicle, comprising the step in which at least one maximum charging limit parameter corresponding to the maximum noise emissions of the motor vehicle or of the energy storage device is specified to the motor vehicle to be charged for the charging process, wherein this specification is used to limit the maximum noise emissions that the motor vehicle or the energy storage device emits during the charging process. The charging limit parameter may expediently be the maximum electric charging power or the maximum electric charging current. The charging limit parameter may be specified for example by the charging station or by the server.

In this embodiment, provision may thus advantageously be made for the motor vehicle not to use the maximum noise limit value in order to regulate or to control the cooling device and the charging power drawn from the charging station, but rather the charging station itself directly or indirectly limits the electric charging power for the charging process of the motor vehicle in order thus to limit the noise emissions of the motor vehicle or of the energy storage device. In other words, in one step, the electric charging power provided to the motor vehicle is thus limited by specified maximum noise emissions, wherein the limitation of the charging power due to the maximum noise emissions has a higher priority than other charging parameters that could permit higher charging powers than the limited charging power. In other words, according to the method, provision is expediently made for the limiting of the charging power based on the maximum noise emissions to be configured to overrule one or more charging power specifications resulting from one or more other parameters of the charging station if these one or more charging power specifications would permit higher charging powers.

The motor vehicle may be for example a plug-in hybrid electric vehicle (PHEV), a battery electric vehicle (BEV) or a fuel cell vehicle (FCEV). The motor vehicle may also be referred to as an electric car.

The electrical energy storage device is a device for storing electrical energy, in particular for driving at least one electric (traction) drive machine. The energy storage device comprises at least one single cell, which forms the electrochemical energy storage cell. Provision is generally made for a plurality of single cells. By way of example, the energy storage device may be a high-voltage storage unit or a high-voltage battery.

A charging point is a charging device at which only one motor vehicle is able to be charged at the same time. Charging stations may have one or more charging points. Charging stations at which multiple motor vehicles are able to be charged at the same time accordingly comprise multiple charging points. The charging station or the charging point is expediently a stationary device.

The maximum noise emissions that the motor vehicle or the energy storage device are allowed to emit during the charging process are the maximum noise emissions of the motor vehicle or of the energy storage device that are allowed to occur during charging. Noise or noise emissions in this connection are understood in particular to mean noise that is liable, in terms of type, extent or duration, to bring about hazards, considerable disadvantages or considerable pollution for the general surroundings or the neighborhood. In one preferred embodiment, the maximum noise emissions may be limited by limiting the noise emissions emitted by the cooling device of the electrical energy storage device. The maximum noise emissions could for example be specified or influenced by rules, standards, technical policies, etc.

Provision may expediently be made, in the methods disclosed here, for the maximum noise emissions that the motor vehicle or the energy storage device are allowed to emit to be limited using:

the day of the week on which the motor vehicle is charged;

the time of day at which the motor vehicle is charged; and/or

the date on which the motor vehicle is charged.

By way of example, some or all days may advantageously be divided into various times of day (throughout the day, at lunchtime, in the evening, at night) at which the maximum noise emissions from the motor vehicle or energy storage device may each be limited to a different extent. The times of day may vary by country or region. By way of example, the following times of day may be defined:

throughout the day: 06:00-22:00

at night: 22:00-06:00

at lunchtime: 13:00-15:00

in the evening: 20:00-22:00

As an alternative or in addition, the maximum noise emissions may be limited to a different extent for example for Sundays and bank holidays and work days. The maximum noise emissions may also be limited to a different extent for any day of the week or for any date. The times of day may also be defined differently for different days of the week.

The noise emissions may advantageously thus be adapted better to any applicable rules and at the same time the highest possible charging power or shortest possible charging times may be achieved.

The methods disclosed here preferably comprise the step in which a surroundings value is acquired, this being directly or indirectly indicative of the noise emissions present in the surroundings. The surroundings value is expediently used when limiting the maximum noise emissions that the motor vehicle or the energy storage device are allowed to emit during the charging process.

The surroundings value is expediently indicative of the noise emissions that are actually emitted, at the location of the charging process, not by the motor vehicle to be charged itself, but rather by other noise sources, or are predicted for these. In this connection, other noise sources are all noise sources that do not belong to the motor vehicle to be charged. Other noise sources are, for example:

the charging station itself or nearby charging stations;

other motor vehicles that are charged or are to be charged at other charging points of the charging station or at nearby charging stations; and/or

other stationary installations that emit noise.

The term “nearby” in the context of the technology disclosed here comprises distances between two objects that are so low that the noise emissions of both objects are generally still able to be perceived together, in particular distances of less than 50 meters or less than 20 meters or less than 15 meters.

Provision may advantageously be made for a microphone for acquiring noise sources, in particular including noise sources that do not belong to the charging station itself. In one preferred embodiment, the noise emission of the charging station and of the motor vehicles to be charged by the charging station may be approximated based on the power demand of the motor vehicles. The charging station may furthermore directly or indirectly limit the noise emissions of the other motor vehicles, in particular using one of the methods disclosed here. In one expedient embodiment, the charging station may thus ensure that specified maximum limit values for the noise emissions are complied with and at the same time the individual motor vehicles are charged as quickly as possible.

A direct communication link may be set up, in particular in wired or wireless form, between the motor vehicle and the charging station comprising the charging point. Any suitable wired or wireless communication standards may be used for this purpose. In one embodiment, a communication device of the charging station transmits the at least one item of information to the motor vehicle in accordance with the DIN SPEC 70121 standard (published in December 2014) and/or the ISO 15118-1 standard (first published in 2013) or standards building thereon.

Provision may likewise be made to set up indirect communication to the motor vehicle. By way of example, the motor vehicles may communicate with the charging station by way of at least one server (also called backend server or backend). The at least one server may for example be operated by the motor vehicle manufacturer, by the charging column operator or by a third party. The at least one server is not provided in the motor vehicle and not provided in the charging station.

The at least one item of information may be acquired by the motor vehicle from the charging point in basically any suitable way.

One item of information of the at least one item of information may be a maximum noise limit value. The maximum noise limit value is directly or indirectly indicative of the maximum noise emissions that the motor vehicle or the energy storage device are allowed to emit during the charging process. By way of example, the maximum noise limit value may be a maximum acoustic pressure limit level able to be perceived at a specified distance. A temporally averaged maximum acoustic pressure may likewise be used as noise limit value. Variables and measuring methods for acquiring noise emissions and for defining a maximum noise limit value for the method disclosed here are known to those skilled in the art, for example from official guidelines and technical standards. In one preferred embodiment, multiple maximum noise limit values are adopted. This is particularly advantageous if other noise limit values apply depending on the time of day and/or depending on the date.

Provision may thus advantageously be made for the motor vehicle to directly or indirectly acquire the maximum noise limit value from the charging point and to use this maximum noise limit value to regulate or control the charging process such that the noise emissions are limited.

One item of information of the at least one item of information from the charging point may be for example the identification number of the charging point. The identification number is expediently the EVSEID identifier (electric vehicle supply equipment identification number), which is allotted for the billing for each charging point. Provision may expediently be made for the maximum noise limit value to be determined using the identification number. In one preferred embodiment, multiple maximum noise limit values are determined. This is particularly advantageous if other noise limit values apply depending on the time of day and/or depending on the date.

In one embodiment, provision may be made for a vehicle user or the motor vehicle (expediently just before arrival at the charging location) to select the charging point, advantageously based on predefined selection criteria, such as for example current or predicted availability of the charging point, current or predicted maximum charging power, price, parking space size, preferred electricity supplier, distance/diversion to a specified destination, etc.

In one embodiment, the maximum noise limit value may be determined in the motor vehicle based on the identification number. As an alternative or in addition, provision may be made for the motor vehicle to receive the maximum noise level value wirelessly from the at least one server and for the maximum noise limit value to have been determined on the at least one server using the identification number.

In one embodiment, each identification number is assigned at least one maximum noise limit value. Advantageously, in addition to the identification number, further parameters may also be taken into consideration. The maximum noise limit values may be determined for example based on a mathematical calculating operation using the identification number or a value stored for an identification number. A multidimensional characteristic diagram is advantageously stored in the motor vehicle or on the at least one server, in which characteristic diagram the various maximum noise limit values are stored as a function of the identification number and preferably also as a function of further parameters.

Further parameters may be for example:

day of the week, time of day and/or date on and/or at which the motor vehicle is charged; and/or

the at least one surroundings value.

The specified maximum charging limit parameter is expediently determined taking into consideration the respective motor vehicle or the motor vehicle type. Trials and/or simulations may be used, for each motor vehicle or each motor vehicle type, to determine the correlation between the charging parameter (for example charging current, charging power) and the noise emitted by the motor vehicle during charging. It is also possible to define vehicle classes that all have essentially the same noise emission behavior during charging.

By way of example, the specified maximum charging limit parameter may be dependent on one or more of the following parameters:

day of the week, time of day and/or date on and/or at which the motor vehicle is charged;

the at least one surroundings value;

vehicle type or vehicle class; and/or the external temperature during the charging process.

The maximum charging limit parameter may be stored with the abovementioned parameters in a characteristic diagram that is stored on a server or in the charging station.

The technology disclosed here relates in particular to a method for charging multiple motor vehicles at multiple charging points that are provided near one another. In each of the motor vehicles, the maximum noise emissions that the motor vehicles are allowed to emit during the charging process are limited using one of the methods disclosed here. The maximum noise limit values and/or charging limit parameters are expediently selected such that noise emissions jointly emitted by the multiple motor vehicles, or noise emissions jointly emitted by the multiple motor vehicles and the multiple charging points, do not exceed a limit value for the surroundings noise emissions.

If for example the noise emissions of all motor vehicles to be charged and possibly all charging stations would lead to a permissible limit value for the surroundings noise emissions (for example limit values of any noise pollution laws) being exceeded, then the noise emissions of some or all motor vehicles are expediently limited (further). Various approaches are conceivable for limiting the noise emissions of the individual motor vehicles.

By way of example, the noise emissions (and thus ultimately the charging powers) of all motor vehicles could be limited by the same amount. If for example a limit value for surroundings noise emissions of 50 dB has to be complied with in a residential area in the evenings and the noise emissions of other noise sources, such as the charging station itself or other stationary structures, are negligible, then an individual motor vehicle at a charging point could be charged using one of the methods disclosed here such that the maximum noise emissions of the motor vehicle or of the energy storage device are limited to 50 dB during the charging process. If in the meantime multiple motor vehicles are charged at the same time using the same charging station, then the charging station reduces the maximum permissible noise emissions of the individual motor vehicles to be charged such that the limit value for the surroundings noise emissions of 50 dB continues to be complied with overall and the vehicles are still charged as quickly as possible. For this purpose, the maximum noise emission limits of the individual motor vehicles may each be lowered by a certain amount.

It is likewise conceivable for the noise emissions of the individual motor vehicles not all to be lowered by the same amount. The lowering of the noise emissions may for example be decided on by the charging station based on other criteria, for example:

maximizing the total charging power of the charging station, such that the space usage for charging is reduced, or homogenizing the charging power output to the various motor vehicles,

wherein the lowering takes place, taking these criteria into consideration, such that the limit value for the surroundings noise emissions is complied with. The state of charge of the individual motor vehicles could also be used as a criterion for lowering individual motor vehicles in order to decide the motor vehicle for which the noise emissions should (additionally) be lowered.

Provision is preferably made for the methods disclosed here not to be performed just at the beginning of the charging process or of the charging processes. Advantageously, the methods disclosed here are performed continuously or at fixed intervals during charging. If for example another motor vehicle is connected to another charging point of the charging station, then the methods disclosed here are expediently performed again.

In other words, the technology disclosed here relates to a method for charging an energy storage unit of a motor vehicle. A charging column may, for example in the DC charging standard PLC, transmit at least the identification number of the charging point (charging station, charging column, wall box, etc.) connected to the motor vehicle.

The motor vehicle may additionally receive, directly from the charging point, the noise limit value (that is to say the current sound level limit or decibel limit) permissible there or the maximum charging power corresponding to the noise.

As an alternative or in addition, the motor vehicle, with regard to the identification number (and preferably based on further boundary conditions such as time of day, day of the week and/or date), determines the permissible noise limit value:

from a list in the motor vehicle (in car); or

through a request for the identification number to the backend server (B2V) communicating with the motor vehicle from the list stored on said server.

The list may store one or more properties of the charging points for the identification numbers of the charging points. A request to a backend server may in particular contain current boundary conditions such as the instantaneously additionally permissible noise in the surroundings of the charging point when the charging point or another entity determines this noise. The maximum noise pollution at the charging motor vehicle or caused by multiple charging motor vehicles may thus be specified and complied with remotely, in particular including dynamically.

The backend server may for example be operated by a motor vehicle manufacturer, by a charging point operator or by other information aggregators. Each motor vehicle is able to regulate its current draw such that the limit of the noise emission for this motor vehicle is not exceeded.

In one embodiment, the technology disclosed here may comprise the following steps:

(1) connecting the motor vehicle and the charging point through a charging current connection;

(2) communicating between the charging point and the motor vehicle;

(3) determining the currently applicable noise limit value; and

(4) limiting the noise emission.

Steps (2) to (4) may possibly be repeated if the boundary conditions in the surroundings of the motor vehicle change. The charging point may directly trigger the trigger for a repetition of the process, or this may be triggered via the communication by way of the backend server.

In order to comply with noise pollution requirements, the technology disclosed here, in particular in the case of the solution with a backend server, results in the advantage that, in the case of multiple vehicles to be charged, the sum is able to be adapted dynamically to the real-time consumption abilities of the vehicles. For example, if a vehicle is charging with relatively low consumption and thus relatively low noise on an EVSE-ID, then other vehicles would be allowed to make more noise without the noise pollution requirements being infringed.

The noise level around the motor vehicle may expediently be determined, for example by a microphone provided in the motor vehicle (for example the hands-free system). The noise level may however also be acquired in a different manner. In one embodiment, the determined noise level around the motor vehicle may be used for classifying and monitoring surroundings, in particular such that the cooling device of the motor vehicle always falls below the surrounding noise level and still provides the cooling power required for charging. By way of example, a frequency image of the surroundings noise may be acquired. Furthermore, expediently, a vehicle user is able to set the intended dominance of the noise emissions of the cooling device and thus influence its charging power.

### BRIEF DESCRIPTION OF THE DRAWING

FIG. 1 shows a method according to an exemplary embodiment of the invention.

### DETAILED DESCRIPTION OF THE DRAWING

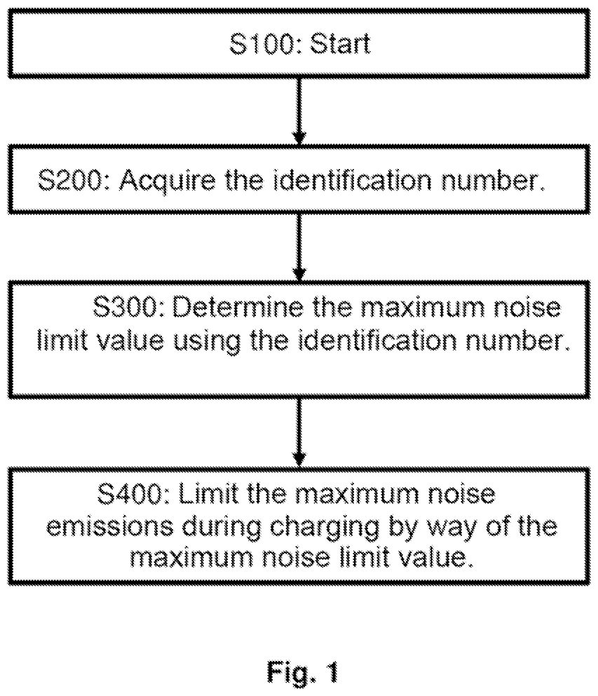

The technology disclosed here is now explained with reference to FIG. 1. In step S100, the method is started. In step S200, the motor vehicle acquires the identification number of the charging point. This may be achieved for example through wired communication. Based on the identification number, the motor vehicle may then determine the maximum noise limit value in step S300, for example by receiving the noise limit value corresponding to this identification number through a server query. Provision may likewise be made for the motor vehicle to receive multiple noise limit values that are linked to this identification number. By way of example, various noise limit values for various times of day may be transmitted. Based on the one or more received noise limit values, in step S400, the maximum noise emissions that the motor vehicle or the electrical energy storage device emit are limited. Provision may be made for the steps to be repeated during charging.

For the sake of legibility, the expression “at least one” has been omitted in some cases by way of simplification. If a feature of the technology disclosed here is described as being singular or undefined, then a plurality thereof is intended to be jointly disclosed at the same time.

The above description of the present invention serves only for illustrative purposes and not for the purposes of restricting the invention. Various changes and modifications are possible within the scope of the invention without departing from the scope of the invention and its equivalents.

1.-14. (canceled)

15. A method for charging at least one electrical energy storage device of a motor vehicle, the method comprising:
acquiring at least one item of information from a charging point; and
limiting maximum noise emissions that the motor vehicle or the at least one electrical energy storage device are allowed to emit during the charging by using the at least one item of information.

16. The method according to claim 15, wherein one item of the at least one item of information is an identification number of the charging point.

17. The method according to claim 15, wherein one item of the at least one item of information is a maximum noise limit value, and wherein the maximum noise limit value is indicative of the maximum noise emissions that the motor vehicle or the at least one electrical energy storage device are allowed to emit during the charging.

18. The method according to claim 17, wherein one item of the at least one item of information is an identification number of the charging point, and wherein the maximum noise limit value is determined using the identification number.

19. The method according to claim 18, wherein the maximum noise limit value is determined in the motor vehicle.

20. The method according to claim 18, wherein the motor vehicle receives the maximum noise limit value from a server.

21. A method for charging at least one electrical energy storage device of a motor vehicle, the method comprising:
specifying at least one maximum charging limit parameter corresponding to maximum noise emissions to the motor vehicle for the charging; and
using a specification to limit the maximum noise emissions that the motor vehicle or the at least one electrical energy storage device are allowed to emit during the charging.

22. The method according to claim 21, wherein the at least one maximum charging limit parameter is a maximum charging power or a maximum charging current.

23. The method according to claim 21, wherein the at least one maximum charging limit parameter is determined taking into consideration a motor vehicle type or a motor vehicle class of the motor vehicle.

24. The method according to claim 21, wherein the maximum noise emissions are limited using at least one of a day of a week, a time of the day, or a date on which the motor vehicle is charged.

25. The method according to claim 21, further comprising:
acquiring at least one surroundings value, wherein:
the at least one surroundings value is indicative of noise emissions present in the surroundings, and
the at least one surroundings value is used to limit the maximum noise emissions.

26. A method for charging multiple motor vehicles at multiple charging points, the method comprising:
in each of the motor vehicles, limiting the maximum noise emissions that the motor vehicles are allowed to emit during the charging using the method according to claim 15,
wherein at least one of maximum noise limit values or charging limit parameters are selected such that noise emissions jointly emitted by the multiple motor vehicles, or noise emissions jointly emitted by the multiple motor vehicles and the multiple charging points do not exceed a limit value for surroundings noise emissions.

27. A motor vehicle comprising:
at least one energy storage device,
wherein the motor vehicle configured to carry out the method according to claim 15.

28. A motor vehicle comprising:
at least one energy storage device,
wherein the motor vehicle is configured:
to acquire at least one item of information from a charging point, and
to limit maximum noise emissions that the motor vehicle or the at least one energy storage device are allowed to emit during a charging process using the at least one item of information; and
wherein the at least one item of information:
is a maximum noise limit value, wherein the maximum noise limit value is indicative of the maximum noise emissions that the motor vehicle of the at least one energy storage device are allowed to emit during the charging process; or
is an identification number of the charging point, wherein the maximum noise limit value is determined using the identification number.

29. A computer product comprising a non-transitory computer readable medium having stored thereon program instructions that, when executed by a processor, carries out the method according to claim 15.
